(19) United States
(12) Patent Application Publication
(10) Pub. No.: US 2014/0291369 A1
(43) Pub. Date: Oct. 2, 2014

(54) ELECTRONIC TAG HOLDING DEVICE

(71) Applicant: Salvatore Marsilla, Emerson, NJ (US)

(72) Inventor: Salvatore Marsilla, Emerson, NJ (US)

(21) Appl. No.: 14/227,867

(22) Filed: Mar. 27, 2014

Related U.S. Application Data
(60) Provisional application No. 61/805,847, filed on Mar. 27, 2013.

(51) Int. Cl. B60R 11/00

(52) U.S. Cl. CPC B60R 11/00; B60R 2011/0026
USPC 224/482; 29/428

(57) ABSTRACT

An electronic tag holding device is provided. The electronic tag holding device includes a back plate support having a front side, a rear side, an upper portion and a lower portion. A receptacle may protrude from the front side of the back plate support forming an opening into the receptacle. The opening is formed to receive the electronic tag. The present invention may include a securing device configured to releasably secure the electronic tag within the receptacle. The present invention may further include at least one suction cup protruding from the rear side of the back plate support, which may attach to an inside of a car windshield.

### CROSS-REFERENCE TO RELATED APPLICATION

This application claims the benefit of priority of U.S. provisional application No. 61/805,847, filed Mar. 27, 2013, the contents of which are herein incorporated by reference.

### BACKGROUND OF THE INVENTION

The present invention relates to an electronic tag holding device and, more particularly, to an electronic tag holding device that maybe easily relocated.

Currently, electronic toll tags, such as E-Z pass® tags are used to swiftly move through tolls. E-Z pass® tags are battery powered RFID transponders. The tags communicate with reader equipment built into lane-based or open-road toll collection lanes. The most common type of tag can be mounted on the inside of the vehicle's windshield behind the rear-view mirror. To mount the tags to the inside of the windshield, hook and loop fastening strips may be used, which need to be glued to your vehicle windshield. The strips are unsightly and are not easily removed from the windshield. This makes cleaning tedious and difficult.

As can be seen, there is a need for a moveable electronic tag holding device.

### SUMMARY OF THE INVENTION

In one aspect of the present invention, an electronic tag holding device comprises: a back plate support comprising a front side, a rear side, an upper portion and a lower portion; a receptacle protruding from the front side of the back plate support forming an opening into the receptacle, wherein the opening is formed to receive the electronic tag; at least one clip disposed near the opening of the receptacle and configured to releasably secure the electronic tag within the receptacle; and at least one suction cup protruding from the rear side of the back plate support.

In another aspect of the present invention, an electronic tag holding device comprises: a back plate support comprising a front side, a rear side, an upper portion and a lower portion; a receptacle protruding from the front side of the back plate support forming an opening near the lower portion of the back plate support leading into the receptacle, wherein the opening is formed to receive the electronic tag; a securing device configured to releasably secure the electronic tag within the receptacle; and at least one suction cup protruding from the rear side of the back plate support.

In another aspect of the present invention, a method of securing an electronic tag to a windshield comprises: providing an electronic tag holding device comprising: a back plate support comprising a front side, a rear side, an upper portion and a lower portion; a receptacle protruding from the front side of the back plate support forming an opening near the lower portion of the back plate support; at least one clip disposed near the opening of the receptacle; and at least one suction cup protruding from the rear side of the back plate support; attaching the at least one suction cup to the windshield of a car; and inserting the electronic tag through the opening and into the receptacle so that the clip releasably secures the electronic tag within the receptacle.

These and other features, aspects and advantages of the present invention will become better understood with reference to the following drawings, description and claims.

### BRIEF DESCRIPTION OF THE DRAWINGS

FIG. 1 is a front top perspective view of the present invention shown in use;

FIG. 2 is a front bottom perspective view of the present invention shown in use;

FIG. 3 is a front bottom perspective view of the present invention;

FIG. 4 is a rear bottom perspective view of the present invention;

FIG. 5 is a front view of the present invention;

FIG. 6 is a bottom view of the present invention;

FIG. 7 is a side view of the present invention; and

FIG. 8 is a section detail view of the present invention along line 8-8 in FIG. 5 demonstrated in use with a windshield of a car.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electronic tag holding device. The electronic tag holding device includes a back plate support having a front side, a rear side, an upper portion and a lower portion. A receptacle may protrude from the front side of the back plate support forming an opening into the receptacle. The opening is formed to receive the electronic tag. The present invention may include a securing device configured to releasably secure the electronic tag within the receptacle. The present invention may further include at least one suction cup protruding from the rear side of the back plate support, which may attach to an inside of a car windshield.

The present invention may include a device that mounts an electronic tag, such as an E-Z Pass® electronic tag. The present invention secures the electronic toll tag to an inside of a windshield of a vehicle in a removable holder that may be secured to the windshield by suction cups. The present invention is thereby a removable holder for an electronic toll tag, preventing possible theft, which does not leave any glue or hook and loop fastener strips to a vehicle windshield. Further, the device does not rattle or make sounds when driving the car with the electronic tag secured.

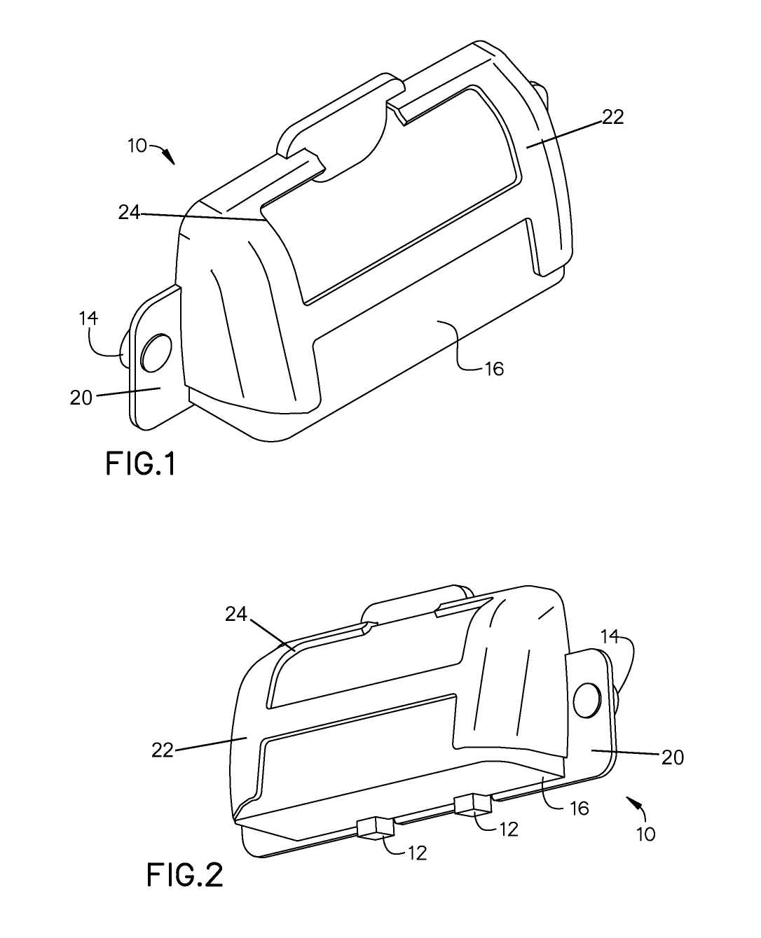

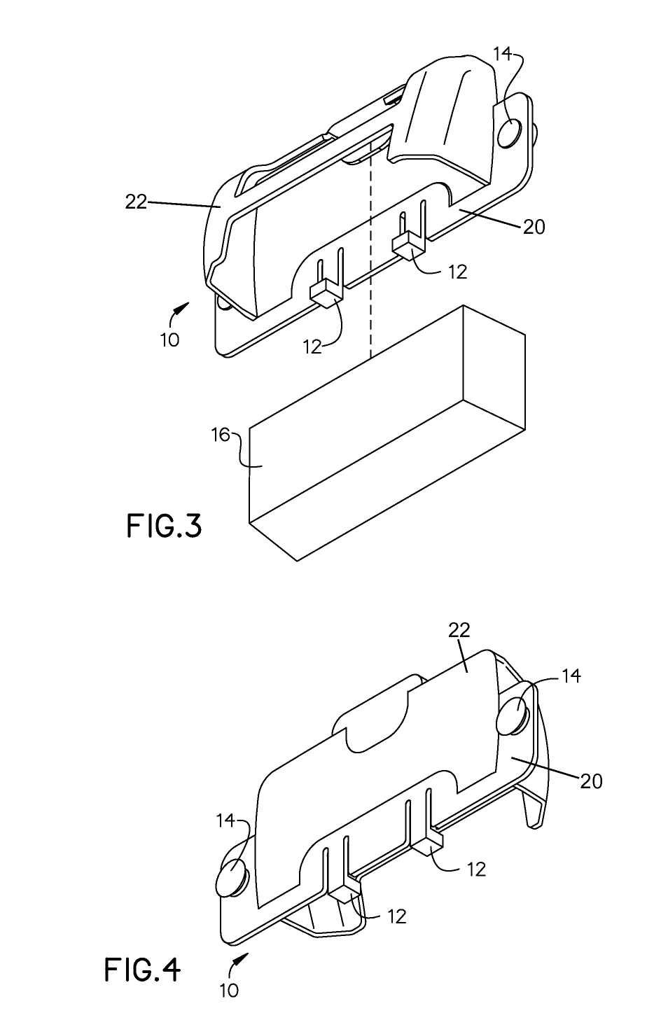

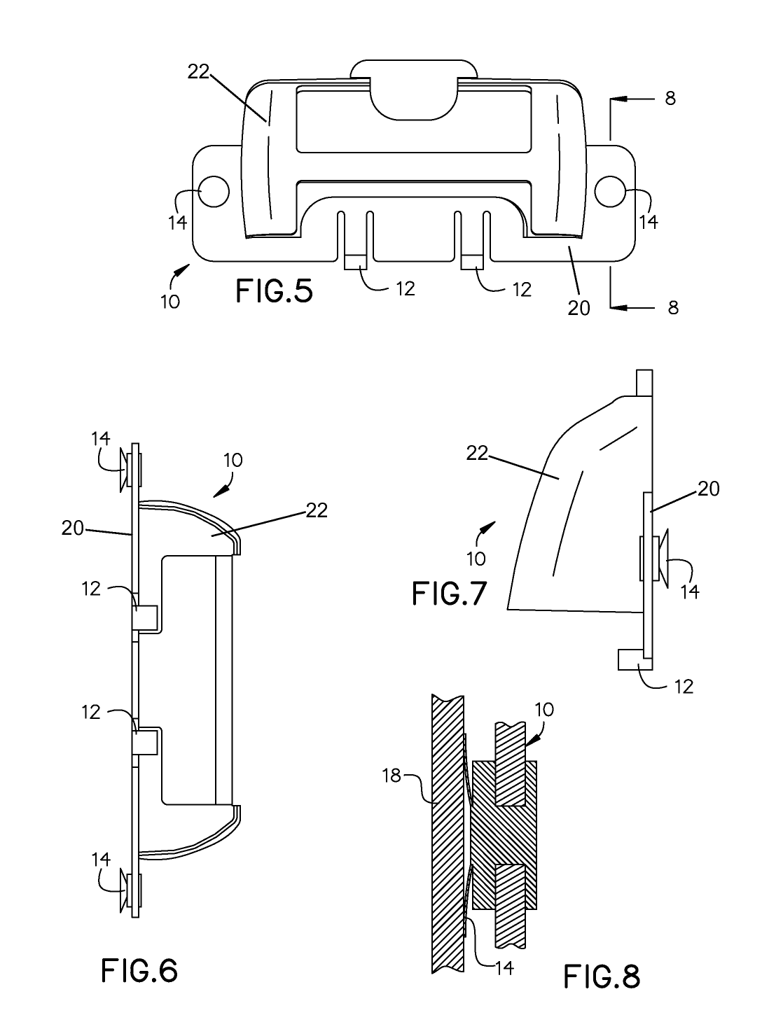

Referring to FIGS. 1 through 8, the present invention includes an electronic tag holding device 10. The electronic tag holding device 10 may secure an electronic tag 16 within, and may be attachable to the inside of a car windshield 18 by suction cups 14. In certain embodiments, the electronic tag 16 may be insertable through the bottom of the electronic tag holding device 10. The electronic tag holding device 10 may include a window 24 and thereby may secure the electronic tag 16 so that the user's account number and phone number may be displayed to the user.

The electronic tag holding device 10 includes a back plate support 20. The back plate support 20 includes a front side, a rear side, an upper portion, and a lower portion. The present invention further includes a receptacle 22. The receptacle 22 may be sized to receive and secure an electronic tag 16, such as an EZpass® module. The receptacle 22 may be protruding from the front side of the back plate support 20. An opening may be formed leading into the receptacle 22 and sized to receive the electronic tag 16. The opening may be formed near the lower portion of the back plate support 20 so that a user may easily insert the electronic tag 16 into the receptacle 22 from the bottom. In certain embodiments the present invention may include anti rattle pegs molded into the receptacle 22.

The present invention may further include a securing device. The securing device may releasably secure the electronic tag 16 within the receptacle 22. In certain embodiments, the securing device may include at least one clip 12. The clip 12 may include an arm attached near the lower portion of the back plate support 20 and protruding towards the receptacle 22. Therefore, the clip 12 may be near the opening of the receptacle 22. In certain embodiments, the at least one clip 12 may include a pair of flexible clips 12. Therefore, the electronic tag 16 may be placed within the receptacle 22, and the clips 12 may retain the electronic tag 16 within the receptacle 22. When removing the electronic tag 16 from the receptacle 22, the user may bend the clips backwards and pull out the electronic tag 16.

The present invention may be releasably attachable to a windshield 18. In such embodiments the present invention may include at least one suction cup 14 protruding from the rear side of the back plate support 20. In certain embodiments, the back plate support 20 may include apertures in which the suction cups 14 are placed, as illustrated in FIG. 8. In certain embodiments, there may be a pair of suction cups 14. To use the suction cups 14, the suction cups 14 may be dampened, the windshield 18 may be cleaned, and the suction cups 14 may be pressed against the windshield 18.

When in use, the user may press the suction cups 14 against the inside of a windshield 18 to secure the back plate support 20 to the windshield 18. A user may place an electronic tag 18 within the receptacle 22 and the user may pass through a toll, paying electronically. Once the user is done using the tag 18, the user may remove the back pate support 10 from the windshield and place the electronic tag holding device 10 within a glove box, another storage area within the car, or on your person to prevent theft of the tag 18 and the electronic tag holding device 10. Alternatively, the user may easily remove the tag 16 from the receptacle 22 by flexing the clips 12.

It should be understood, of course, that the foregoing relates to exemplary embodiments of the invention and that modifications may be made without departing from the spirit and scope of the invention as set forth in the following claims.

What is claimed is:

1. An electronic tag holding device comprising:
a back plate support comprising a front side, a rear side, an upper portion and a lower portion;
a receptacle protruding from the front side of the back plate support forming an opening into the receptacle, wherein the opening is formed to receive the electronic tag;
at least one clip disposed near the opening of the receptacle and configured to releasably secure the electronic tag within the receptacle; and
at least one suction cup protruding from the rear side of the back plate support.

2. The electronic tag holding device of claim 1, wherein the opening is formed near the lower portion of the back plate support

3. The electronic tag holding device of claim 1, wherein the at least one clip comprises a flexible clip.

4. The electronic tag holding device of claim 1, wherein the at least one clip comprises a pair of clips.

5. The electronic tag holding device of claim 1, wherein the at least one suction cup comprises a pair of suction cups.

6. An electronic tag holding device comprising:
a back plate support comprising a front side, a rear side, an upper portion and a lower portion;
a receptacle protruding from the front side of the back plate support forming an opening near the lower portion of the back plate support leading into the receptacle, wherein the opening is formed to receive the electronic tag;
a securing device configured to releasably secure the electronic tag within the receptacle; and
at least one suction cup protruding from the rear side of the back plate support.

7. The electronic tag holding device of claim 6, wherein the securing device comprises at least one clip disposed near the opening of the receptacle and configured to releasably secure the electronic tag within the receptacle.

8. A method of securing an electronic tag to a windshield comprising:
providing an electronic tag holding device comprising:
a back plate support comprising a front side, a rear side, an upper portion and a lower portion;
a receptacle protruding from the front side of the back plate support forming an opening near the lower portion of the back plate support;
at least one clip disposed near the opening of the receptacle; and
at least one suction cup protruding from the rear side of the back plate support;
attaching the at least one suction cup to the windshield of a car; and
inserting the electronic tag through the opening and into the receptacle so that the clip releasably secures the electronic tag within the receptacle.
